(19) United States
(12) Patent Application Publication
(10) Pub. No.: US 2025/0310895 A1
(43) Pub. Date: Oct. 2, 2025

(54) ADAPTIVE FE LINEARITY WITH NON-LINEAR PA

(71) Applicant: Cisco Technology, Inc., San Jose, CA (US)

(72) Inventors: Sivadeep R. KALAVAKURU, Pleasanton, CA (US); Clark A. CARTY, Brunswick, OH (US)

(21) Appl. No.: 18/617,277

(22) Filed: Mar. 26, 2024

(51) Int. Cl. H04W 52/24; H04W 52/26

(52) U.S. Cl. CPC H04W 52/241; H04W 52/262

(57) ABSTRACT

The embodiments herein describe using non-linear PAs (rather than linear PAs) in analog FEs in network devices, such as APs. In one embodiment, a mode of operation of the non-linear PA is switched in response to conditions of a wireless link. When satisfying a performance threshold, the AP operates the non-linear PA in a High Linearity Operating mode where the PA is biased at a higher voltage and a backoff region of the PA is increased. If the performance threshold is not satisfied, the AP operates the non-linear PA in a low (or mid) Linearity Operating mode where the PA is biased at a lower voltage and the backoff region of the PA is decreased. In another embodiment, the non-linear PA can be used to support Standard Power used by Automated Frequency Coordination.

### TECHNICAL FIELD

Embodiments presented in this disclosure generally relate to using non-linear power amplifiers (PAS) in analog front ends (FEs).

### BACKGROUND

With the development of new features of IEEE 11be/WiFi7, current radio frequency (RF) FE design of access points (APs) may be insufficient. Specifically, multi-link devices can have several modes of operations which are linked to capabilities of the FE and a RF integrated circuit (RFIC). For example, there is a need for the FEs to operate at higher modulation (M13 4096 (4k) quadrature amplitude modulation (QAM)) in IEEE 802.11be APs and for higher equivalent isotropically radiated power (EIRP), which is currently limited to 17 dBm per path in Standard Power (SP) with Automated Frequency Coordination (AFC).

FE modules (FEMs) in APs typically contain one PA per radio where each PA functions independently. To support multi-link operation (MLO) with this design, there is only one PA per radio link. Although the initial deployments of MLO will likely be, in the simplest case, only single, two-link MLO, it is expected that future APs will support multiple radios, each supporting more than two links which means additional PAs have to be added. However, having too many PAs in the AP is not only cost-inefficient, but also the total power draw of the PAs might be greater than the maximum power available from Power over Ethernet (POE), which limits where the APs can be placed.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless network device, according to one embodiment.

FIG. 2 illustrates a FE module in a wireless network device, according to one embodiment.

FIG. 3 is a flowchart for switching between operating modes of a non-linear PA, according to one embodiment.

FIGS. 4A-4D include charts illustrating operating parameters of a non-linear PA, according to one embodiment.

FIG. 5 is a flowchart for switching a non-linear PA between standard power and low power indoor modes of AFC, according to one embodiment.

FIGS. 6A-6F include charts illustrating operating parameters of a non-linear PA, according to one embodiment.

FIG. 7 depicts an example computing device configured to perform various aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a network device that includes an antenna and an analog front end (FE) coupled to the antenna, the analog FE including a non-linear power amplifier (PA). The network device is configured to upon determining a wireless link satisfies a first performance threshold, adjust a bias voltage and a backoff region of the non-linear PA to a first voltage value and to a first backoff region, respectively, and upon determining the wireless link does not satisfy the first performance threshold, adjust the bias voltage and the backoff region of the non-linear PA to a second voltage value and to a second backoff region, respectively.

Another embodiment presented in this disclosure is an access point (AP) that includes an antenna and an analog front end (FE) coupled to the antenna, the analog FE including a non-linear power amplifier (PA). The AP is configured to determine that the AP can operate in Standard Power (SP) of Automated Frequency Coordination (AFC), increase a bias voltage of the non-linear PA, and decrease a backoff region of the non-linear PA.

Another embodiment presented in this disclosure is a method that includes upon determining a wireless link satisfies a first performance threshold, adjusting a bias voltage and a backoff region of a non-linear PA to a first voltage value and to a first backoff region, respectively, wherein the non-linear PA is coupled to an antenna in a network device, and upon determining the wireless link does not satisfy the first performance threshold, adjusting the bias voltage and the backoff region of the non-linear PA to a second voltage value and to a second backoff region, respectively.

### EXAMPLE EMBODIMENTS

The embodiments herein describe using non-linear PAS (rather than linear PAs) in analog FEs in network devices, such as APs. The non-linear APs can be used in radios with vendor dependent digital pre-distortion (DPD). Using a non-linear PA for supporting multi-links of WiFi7 can be solution to the above problems of operating at higher modulation coding schemes (MCS) and improving EIRP. Moreover, embodiments herein can improve the PA efficiency by optimizing the peak to average power ratio (PAPR).

In one embodiment, a mode of operation of the non-linear PA is switched in response to conditions of a wireless link. For example, an AP can use a signal-to-noise ratio (SNR) to monitor a budget of the wireless link. When the link budget permits, the AP operates the non-linear PA in a High Linearity Operating mode where the PA is biased at a higher voltage (e.g., 4 V or higher) and a backoff region of the PA is increased (e.g., to 8-10 dB) to support a higher data rate (e.g., 4k QAM) and a higher MCS. If the link budget falls (e.g., the SNR decreases), the AP operates the non-linear PA in a low (or mid) Linearity Operating mode where the PA is biased at a lower voltage (e.g., less than 4 V) and the backoff region of the PA is decreased (e.g., to 3-4 dB) relative to the High Linearity Operating mode. In this mode, the PA can provide more RF power (which helps if the client device is further away from the AP) but operates at a lower MCS (e.g., a lower QAM rate). One advantage of using a non-linear (rather than linear) PA is that the backoff region can be adjusted. In linear PAs (especially mid to low power linear PAs), the backoff regions cannot be adjusted as can be done with non-linear PAS.

In another embodiment, the non-linear PA has different operating settings based on the results of performing AFC. AFC is a coordination system for using specific RF spectrums. AFC uses a registered database of all the bands in use by various types of radio frequency services in a particular area. It is often used by Wi-Fi APs that operate in the newly allocated 6 GHz band (5.925-7.125 GHZ). AFC can indicate whether an AP should operate as a low power, indoor (LPI) AP or as a standard power (SP) AP which can transmit at increased power levels relative to LPI. If the AP can operate in the SP mode, the AP can set the non-linear PA to have a small backoff region (e.g., 2-4 dB) and a high bias voltage (e.g., greater than 4 V) in order to provide sufficient RF power to operate in the SP mode. If the AP operates in the LPI mode, the AP can set the non-linear PA to have an increased backoff region (e.g., 12 dB or greater) and a lower bias voltage (e.g., less than 4 V) to conserve power. In this manner, rather than having to use a higher power linear PA to support SP mode, a lower power, non-linear PA can be used to enable SP mode, which saves costs (since lower power PAs cost less) and saves power.

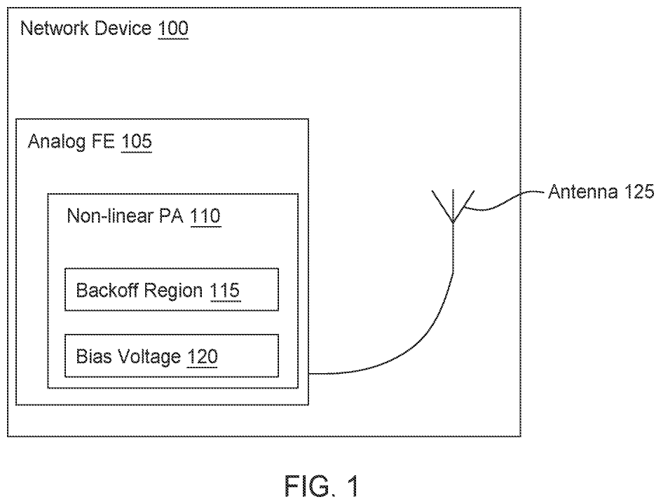

FIG. 1 illustrates a wireless network device 100, according to one embodiment. The network device 100 can be an access point (AP), a client device (e.g., a smartphone or laptop), or a wireless station (STA). In this disclosure, the network device 100 is often referred to as an AP although it is not limited to such.

The network device 100 includes an analog FE 105 which interfaces with an antenna 125 that can transmit and receive wireless signals. Although not shown, the analog FE 105 can be coupled between an analog-to-digital converter (ADC) and/or a digital-to-analog converter (DAC) and the antenna 125. In FIG. 1, the analog FE 105 includes a non-linear PA 110 but can also include a variety of RF components such as filters, switchers, low-noise amplifiers (LNAs), and the like.

The linearity of a PA describes how linear the PA operates at a certain operating point, and the resulting error vector magnitude (EVM). The EVM determines the data rate the PA can sustain for a particular link budget. The backoff region 115 indicates the amount of power a PA 110 is reduced relative to a saturation power (Psat) to avoid clipping. For example, AP FEs are often designed based on linear PAs with a Psat of −32 dBm and a larger PA backoff of 8-10 dBm to avoid clipping. That is, “backing off” from the maximum Psat that the linear PA can consume helps to avoid clipping and improves the peak to average power ratio (PAPR). A backoff region of 8-10 dBM limits a traditional linear PA to 17 dBm at the antenna connector but meets indoor 250 mW regulatory limitation (for 6 dBi antenna gain). Further, certain features such as USB/External Module Port/CPU Throughput Throttle are often disabled to operate under the available PoE budget.

Unlike linear PAs (especially linear PAs that are low to mid power), the backoff region of non-linear PAs 110 can be adjusted. As such, adaptive FE techniques can be applied to the non-linear PA 110 since its backoff region 115 can be more readily adjusted than a linear PA.

In addition, a bias voltage 120 of the non-linear PA 110 can be adjusted. The bias voltage is the voltage provided by the network device 100 in order to power the PA 110. The bias voltage 120 is also referred to as Vcc in the discussion below and can range from, e.g., 2-5 volts. In one embodiment, the network device 100 includes a power management integrated circuit (PMIC) for adjusting the bias voltage 120.

It has been a delicate balance to maximize regulatory the EIRP limit to deliver best possible coverage and RF performance for customers, while still being able to operate according to IEEE 802.3at (25.5 W), as many enterprise deployments still use PoE powered switches. With the introduction of IEEE 802.11be and enabling AFC to operate in SP mode, network devices are reaching hardware design limitations of the analog FEs. To overcome these hardware limitations, the network device 100 can implement an adaptive FE with higher linearity and EIRP using non-linear PAs 110.

In one embodiment, a mode of operation of the non-linear PA 110 is switched in response to conditions of a wireless link. For example, the network device 100 (or a network controller such as a wireless LAN controller (WLC)) can monitor a budget of a wireless link between the network device 100 and another wireless device (e.g., a client device, AP, STA, etc.). When the link budget permits, the network device 100 operates the non-linear PA 110 in a High Linearity Operating mode where the bias voltage 120 of the PA 110 is set at a higher voltage (e.g., 4 V or higher) and where the backoff region 115 of the PA 110 is increased (e.g., to 8-10 dB) to support a higher data rate (e.g., 4096 QAM) and MCS (e.g., MCS11-13).

By biasing the PA 110 at a high biasing voltage, the High Linearity Operating mode provides an optimized transmit (TX) noise floor and EVM to sustain higher MCS (e.g., MCS11-13). Further, this mode is enabled by adjusting to a higher PA backoff region 115 (e.g., 8-10 dB) to sustain higher QAM. Moreover, a higher backoff region 115 limits clipping without degrading EVM.

If the link budget falls (e.g., the SNR decreases), the network device 100 can switch the non-linear PA 110 into a low (or mid) Linearity Operating mode where the bias voltage 120 of the PA 110 is set to a lower voltage (e.g., less than 4 V) and the backoff region 115 is decreased (e.g., to 3-4 dB) relative to the value of the backoff region 115 used when in the High Linearity Operating mode. In this mode, the PA 110 can provide more RF power (which helps when the other network device is further away from the network device 100) but the network device 100 operates at a lower MCS (e.g., MCS0-7).

In the Low (or Mid) Linearity Operating mode, the bias voltage 120 of the PA is biased at a lower Vcc but still has a usable TX noise floor/EVM to sustain a lower MCS (e.g., MCS0-7). This mode is enabled by lowering the PA backoff region (3-4 dB) to sustain a satisfactory data rate (e.g., 64-QAM) while permitting some clipping but achieving higher RF TX Power (including EIRP). That is, reducing the backoff region 115 permits the non-linear PA 110 to increase its TX power, which can increase the range of the radio of the network device 100 to successfully communicate with network devices that are further away.

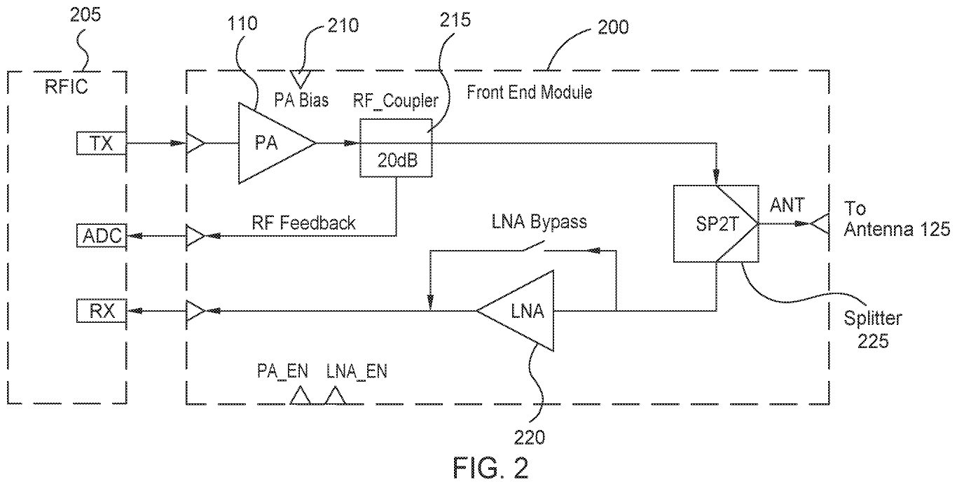

FIG. 2 illustrates a FE module (FEM) 200 in a wireless network device, according to one embodiment. For example, the FE 105 in the network device 100 can be implemented using the FEM 200 in FIG. 2.

The FEM 200 is coupled to a radio frequency integrated circuit (RFIC) 205 (e.g., a network IC) that provides TX data to the FEM 200 and receives receive (RX) data from the FEM 200. The RFIC 205 can include ADCs and DACs for converting analog signals to digital signals and vice versus.

The FEM 200 includes the non-linear PA 110, an RF coupler 215, a LNA 220, a splitter 225, and other various components. The non-linear PA 110 can operate as discussed above to form an adaptive FE where the bias voltage and its backoff region can be adjusted. In this example, the FEM 200 includes a PA bias connector 210 for receiving the bias voltage for the PA 110. For example, a PMIC may be used to provide different power levels to the PA bias connector 210.

The output of the PA 110 is coupled to the RF coupler 215 which can provide a RF feedback signal to an ADC in the RFIC 205. The output of the RF coupler 215 is connected to the splitter 225.

When transmitting data, the splitter 225 provides the amplified TX data provided by the PA 110 and the RF coupler 215 to an antenna connector that is coupled to the antenna 125 (not shown in FIG. 2). In contrast, when receiving data, the splitter 225 provides data received by the antenna 125 to the LNA 220 which amplifies the RX data before forwarding it to the RFIC 205.

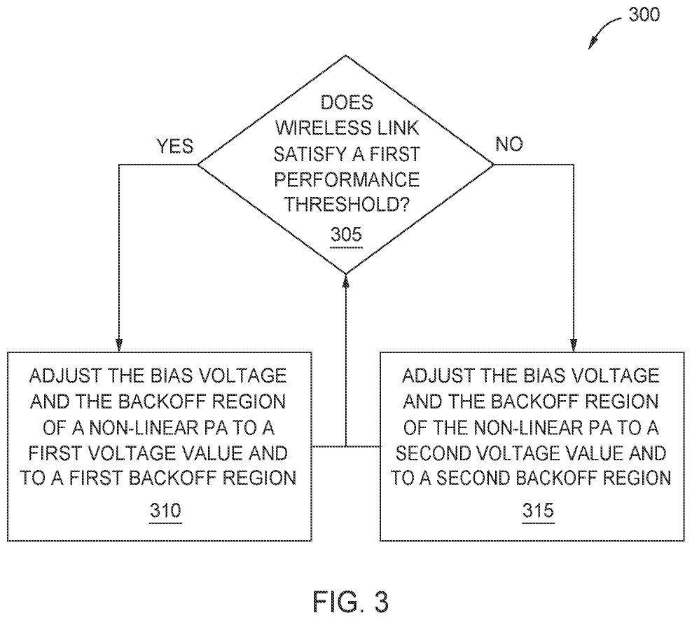

FIG. 3 is a flowchart of a method 300 for switching between operating modes of a non-linear power amplifier, according to one embodiment. At block 305 a network device (e.g., the network device 100 or a WLC) determines whether a wireless link satisfies a first performance threshold. A variety of different performance metrics can be monitored to determine whether they satisfy a performance threshold. For example, the network device may monitor a link budget that indicates a data rate (e.g., MCS or 1k/4k QAM) that can be supported in wireless link. The performance threshold may be based on a SNR, where a higher SNR can support a higher data rate than a lower SNR. However, these are just examples of various performance metrics that can be monitored by the network device.

If the wireless link satisfies the performance threshold, the method 300 proceeds to block 310 where the network device adjusts the bias voltage and the backoff region of a non-linear PA in the analog FE to a first voltage and to a first backoff region, respectively. In general, the first bias voltage and the first backoff region permit the analog FE to support a higher data rate (e.g., MCS11-13 and/or 4k QAM).

In one embodiment, at block 310, the network device operates the non-linear PA in the High Linearity Operating mode discussed in FIG. 1. In this mode, the bias voltage is set at a higher voltage (e.g., 4V or higher, or 5V or higher) and the backoff region is larger (e.g., to 8-10 dB) to avoid clipping and provide a lower EVM. As discussed above, by biasing the PA at a high biasing voltage, the High Linearity Operating mode provides an optimized transmit TX noise floor and EVM to sustain higher MCS (e.g., MCS11-13). Further, this mode is enabled by adjusting to a higher PA backoff region (e.g., 8-10 dB) to sustain higher QAM. Moreover, a higher backoff region limits clipping without degrading EVM.

However, if at block 305 the wireless link does not satisfy the performance threshold, the method 300 instead proceeds to block 315 where the network device adjusts the bias voltage and the backoff region of the non-linear PA to a second voltage value and a second backoff region, respectively. In general, the second bias voltage and the second backoff region permit the analog FE to support a lower data rate (e.g., MCS0-7 and/or 64-QAM).

In one embodiment, at block 315, the network device operates the non-linear PA 110 in the Low (or Mid) Linearity Operating mode where the bias voltage of the PA is set to a lower voltage (e.g., less than 4 V) and the backoff region is decreased (e.g., to 3-4 dB) relative to the value of the backoff region used at block 310. In this mode, the PA can provide more RF power (which helps when the other network device using the wireless link is further away from the network device) but the network device operates at a lower MCS (e.g., MCS0-7).

As discussed above, in the Low (or Mid) Linearity Operating mode, the bias voltage of the PA is biased at a lower Vcc but still has a usable TX noise floor/EVM to sustain a lower MCS (e.g., MCS0-7). This mode is enabled by adjusting to a lower PA backoff region (3-4 dB) to sustain a satisfactory data rate (e.g., 64-QAM) while permitting some clipping but achieving higher RF TX Power (including EIRP). That is, reducing the backoff region permits the non-linear PA 110 to increase its TX power, which can increase the range of the radio of the network device to successfully communicate with network devices that are further away, which could be the reason why the performance threshold (e.g., a minimum SNR) was not satisfied at block 305.

After performing blocks 310 and 315, the method 300 can return to block 305 to continue to monitor one or more performance metrics (e.g., link budget, SNR, etc.) to determine whether the wireless link satisfies the performance threshold. In this manner, the network device can dynamically switch between the two different modes of operation defined by blocks 310 and 315 as conditions of the wireless link changes in real-time.

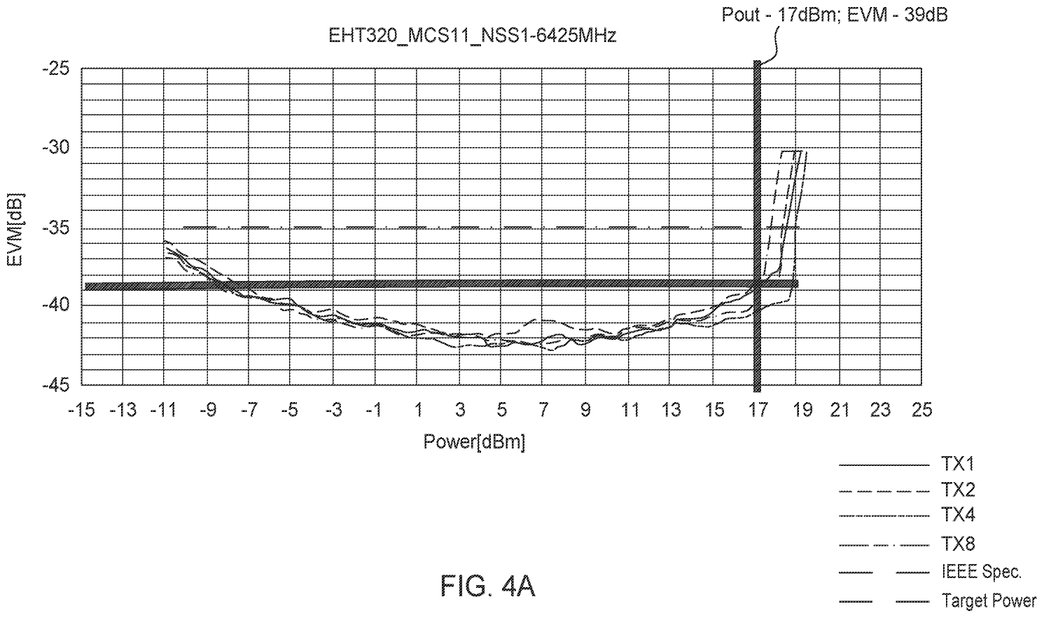

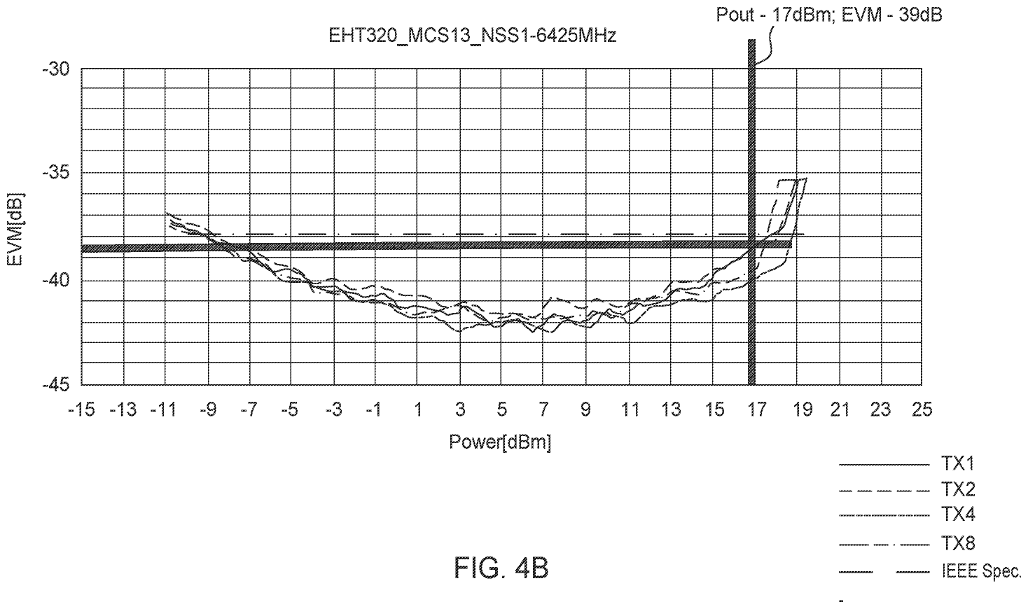

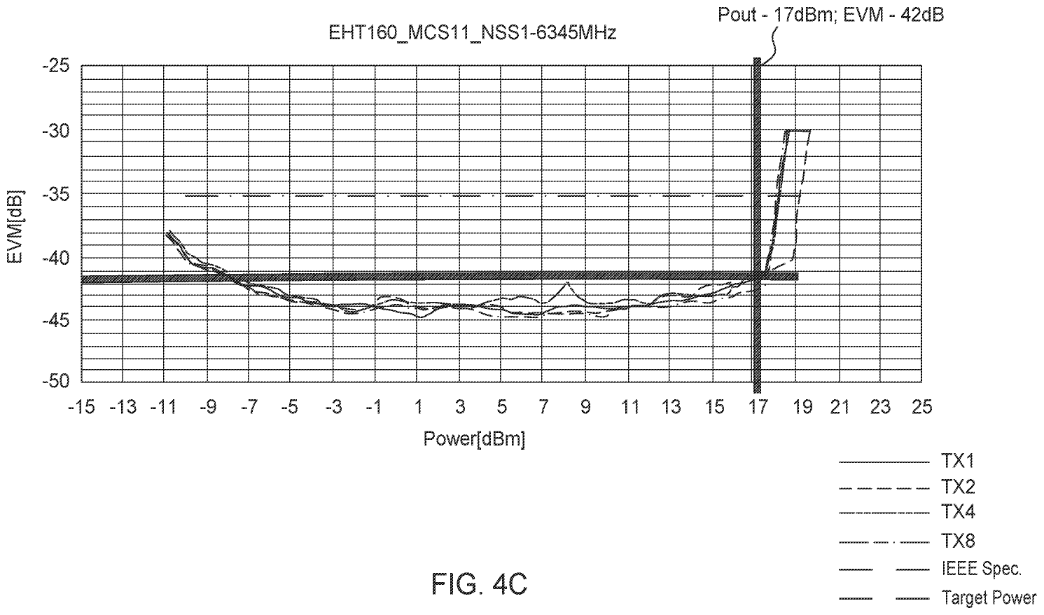

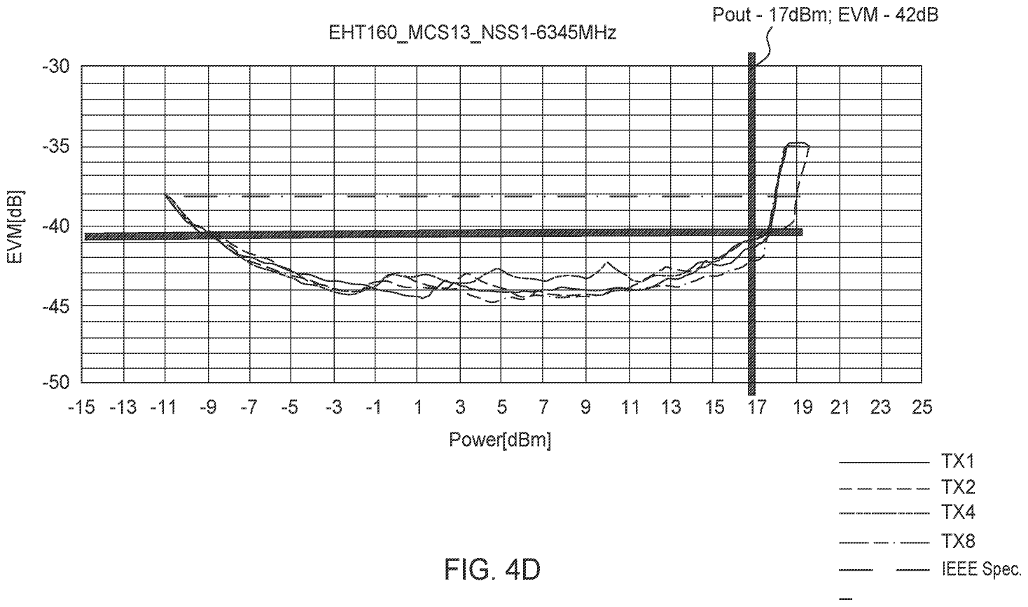

FIGS. 4A-4D include charts illustrating operating parameters of a non-linear power amplifier, according to one embodiment. The four charts are operating with the non-linear PA in the High Linearity Operating mode as discussed at block 310 of FIG. 3, wherein the bias voltage and the backoff region are increased, relative to operating in the Low or Mid Linearity Operating mode discussed at block 315.

The two charts in FIGS. 4A and 4B indicate the performance of a non-linear PA operating in the High Linearity Operation mode (with the use of DPD) with a bandwidth of 320 MHz (within the 6 GHz band) and operating at MCS 11 (FIG. 4A) and at MCS 13 (FIG. 4B). As shown, the FEM containing the non-linear PA (referred to as a non-linear FEM) can achieve a total output power of −17 dBm with an EVM of −39 dB at that power level.

The two charts in FIGS. 4C and 4D indicate the performance of a non-linear PA operating in the High Linearity Operation mode (with the use of DPD) with a bandwidth of 160 MHz (within the 6 GHz band) and operating at MCS 11 (FIG. 4C) and at MCS 13 (FIG. 4D). As shown, the non-linear FEM containing the non-linear PA can achieve a total output power of −17 dBm with an EVM of −42 dB at that power level.

The charts in FIGS. 4A-4D illustrate that the EVM of the non-linear FEMs supports the data rates (e.g., QAM data rates) needed for MCS 11 and MCS 13. The SNR needed at the receiver side to accept 4k-QAM is more than 40 dB (or equivalently, EVM>−40 dB), which is high for a typical Wi-Fi scenario. Nonetheless, at 160 MHz, the two right charts in FIG. 3 indicate the non-linear FEMs can achieve an EVM of −42 dB, thereby achieving 4k-QAM.

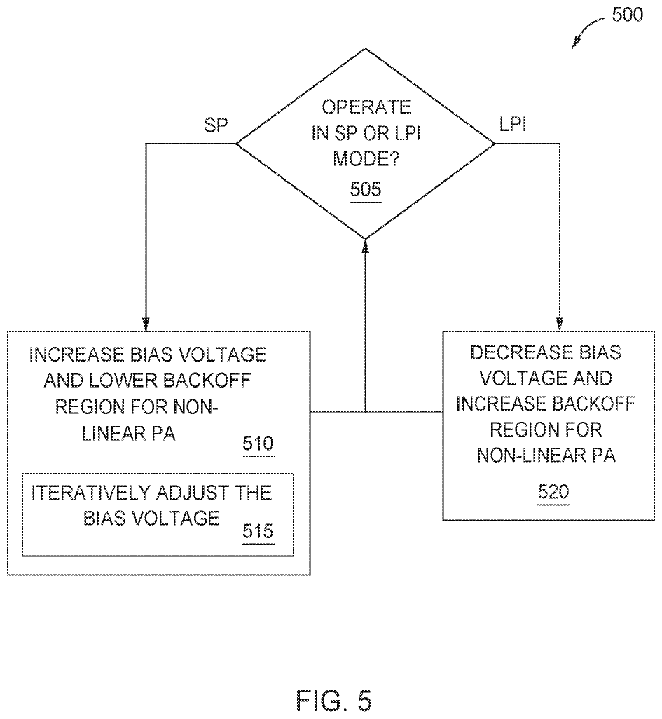

FIG. 5 is a flowchart of a method 500 for switching a non-linear PA between SP and LPI modes of AFC, according to one embodiment. At block 505 a network device (e.g., the network device 100 or a WLC) determines whether an AP can operate in SP or LPI modes. For example, the AP can perform AFC to determine which mode it should operate in, or a WLC (or some other device) can perform AFC and then instruct the AP which mode it should operate in. The specifics of performing AFC are outside the scope of this disclosure, and as such are not discussed in detail. That is, the embodiments herein are not limited to any particular method or technique of performing AFC in order to determine whether an AP should operate as a SP AP or a LPI AP.

If the AP can operate in the SP mode, the method 500 proceeds to block 510 where the AP increases the bias voltage of the non-linear PA and lowers its backoff region. For example, the bias voltage may be increased to 4V or greater (e.g., 5V) and have a backoff region of 2-4 dB. Reducing the backoff region and increasing the bias voltage can increase the range of the radio containing the non-linear PA. In this manner, rather than having to use a higher power linear PA, a lower power, non-linear PA can be used to enable SP mode, which saves costs (since lower power PAs cost less) and saves power.

In one embodiment, at block 510, the FE is operated much closer to Psat-32 dBm with a lower PA backoff region of 3-4 dB (depending on clipping needed). In addition, the operating state of the non-linear PA can be adaptively changed to increase overall FE Gain to transmit at a higher Pout of 23 dBm/Path (Pout-27 dBm along with −4 dB post FEM losses caused by components between the PA and the antenna connector). Further, at block 510, a PSD-23 dBm/MHz and EIRP-36 dBm can be leveraged when the AP has AFC clearance to operate in the SP mode while meeting-6 dB I/N.

In one embodiment, when increasing the bias voltage of the non-linear PA, at sub-block 515 the AP iteratively adjusts the bias voltage using a step size over a predetermined period of time. That is, rather than changing the bias voltage from a current voltage to the desired, higher bias voltage in one step (e.g., directly from 3.2 V to 5 V), the AP can use a series of iterative steps to increase the voltage. For example, the step size may range from 0.1 V to 0.25V, which can depend on the specific hardware implementation of the non-linear PA. Using a plurality of iterative steps (with a fixed time duration at each step) to increase the bias voltage can maintain a 50 ohm impedance matching of the FE, and prevent the PA from becoming unstable.

Returning to block 505, if the results of perform AFC indicate the AP should operate in the LPI mode, the method 500 instead proceeds to block 515 where the AP decreases the bias voltage and increases the backoff region of the non-linear PA. For example, the bias voltage may be 3.2 V and the backoff region can be −10 dBm or more (or −12 dBm or more). Since in LPI the TX power of the AP should be reduced, the non-linear PA has to output less power. Thus, the bias voltage can be decreased and the backoff region increased to conserve power at the non-linear PA and still provide satisfactory performance.

In this manner, rather than having to use a higher power linear PA, a lower power non-linear PA can be used to enable both SP and LPI modes, which saves costs (since lower power PAs cost less) and can conserve power (since lower power PAS consume less power that higher power PAs).

After performing blocks 510 and 315520, the method 500 can return to block 505 to continue to perform AFC (e.g., at intervals). In this manner, the network device can dynamically switch between the SP and LPI modes defined by blocks 510 and 520 as wireless conditions at the AP change.

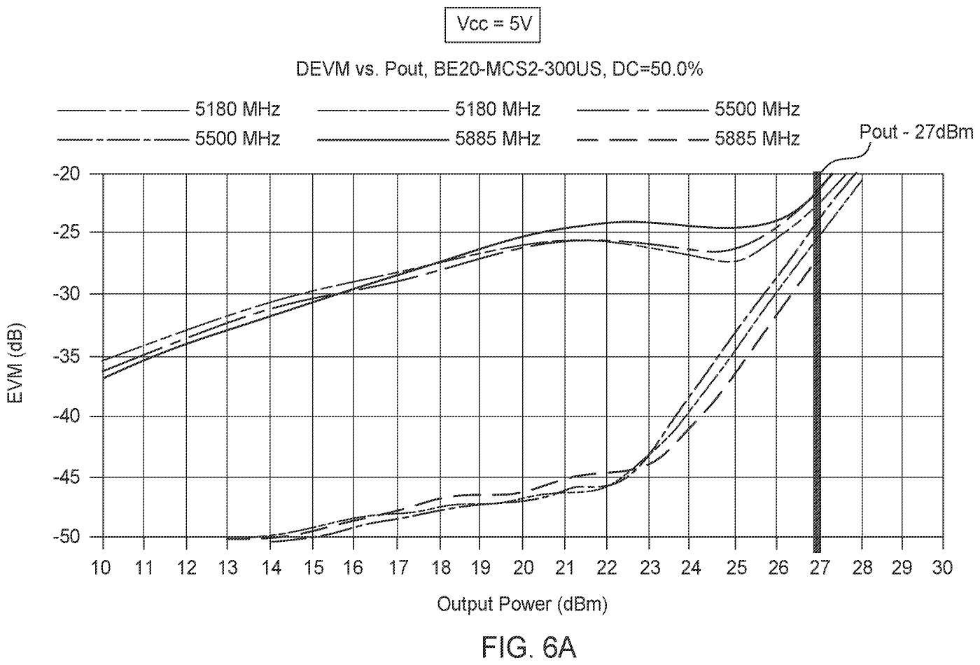

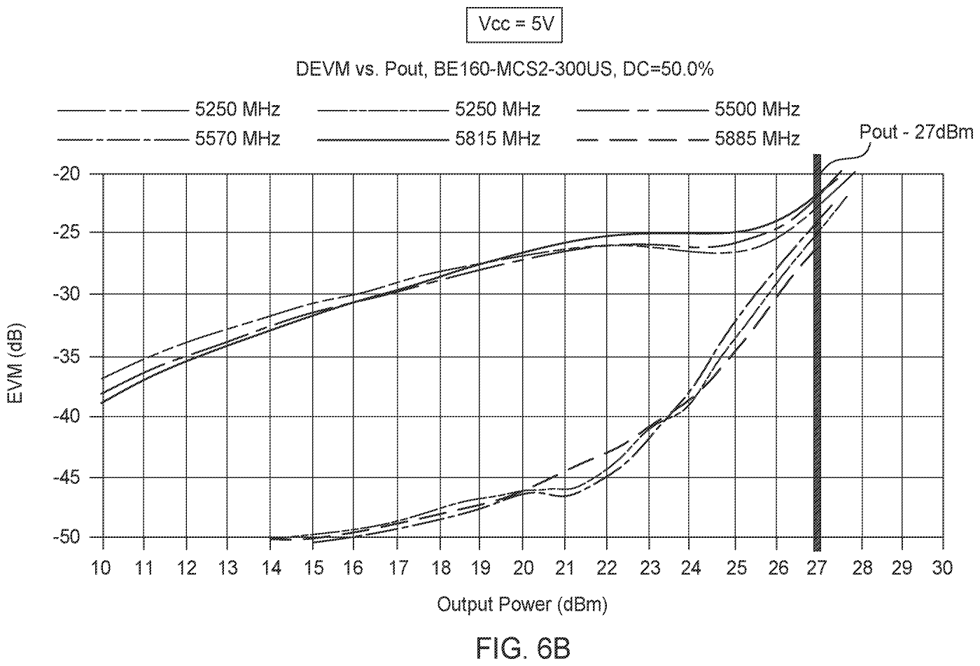

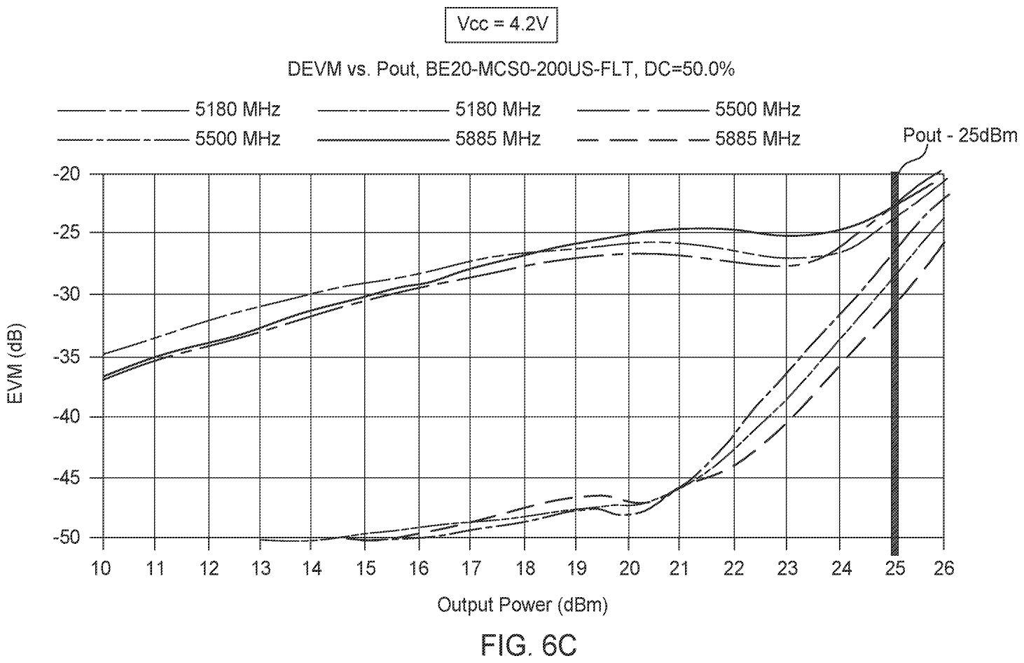

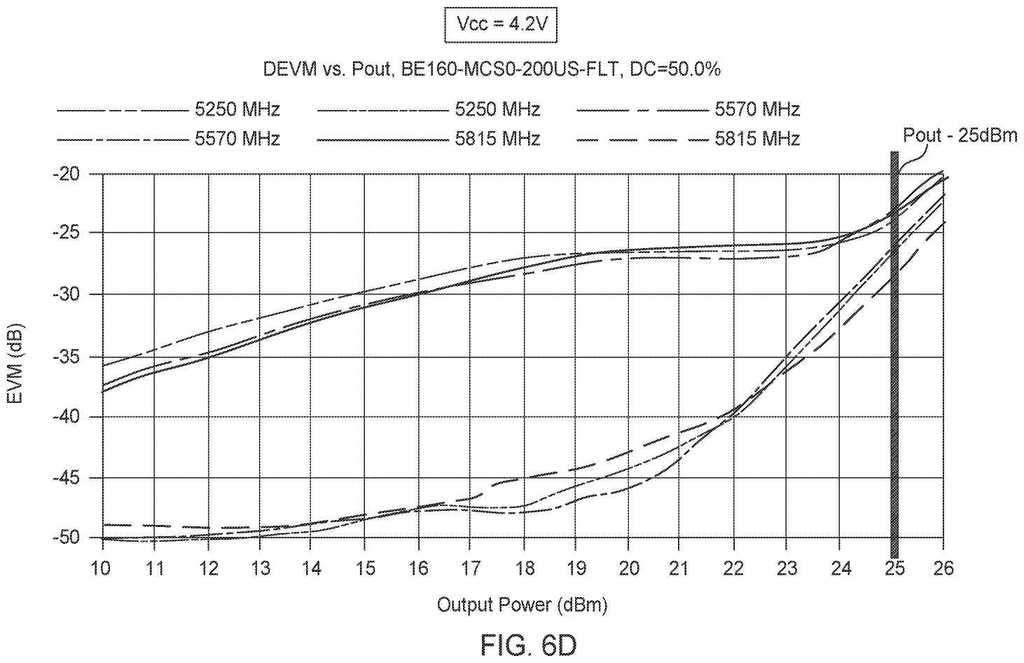

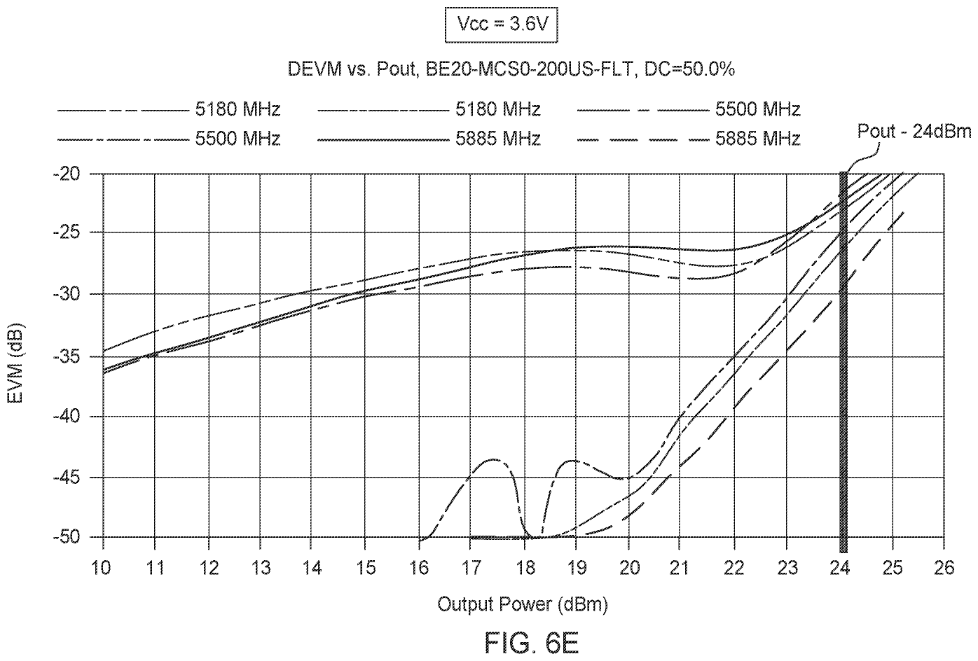

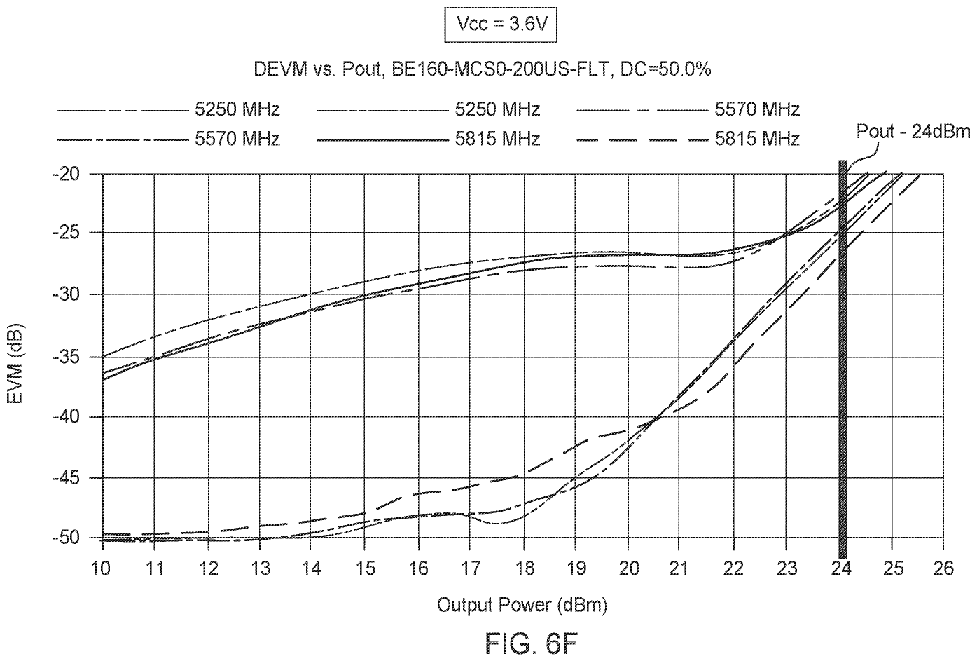

FIGS. 6A-6F include charts illustrating operating parameters of a non-linear power amplifier, according to one embodiment. That is, the charts in FIGS. 6A-6F illustrate different non-linear PA operating points with 3 dB higher Pout per path (total power of 29 dBm+6 dBi; EIRP-35 dBm at EVM-25 dB (MCS0-6)) and respective EVM improvements. FIGS. 6A, 6C, and 6E correspond to a bandwidth of 20 MHz (in the 5 GHz band) while FIGS. 6B, 6D, and 6F correspond to a bandwidth of 160 MHz (in the 5 GHz band). In FIGS. 6A and 6B, the non-linear PA is biased at 5V, in FIGS. 6C and 6D the non-linear PA is biased at 4.2V, and in FIGS. 6E and 6F the non-linear PA is biased at 3.6V. The charts in FIGS. 6A-6F illustrate that by increasing the bias voltage, the output power of the PA can be increased (e.g., from −24 dBM to −27 dBm) in order to provide the higher output power that is permitted in the SP mode of AFC. Thus, a low to mid power non-linear PA can be used to provide as much power as is permitted by the SP mode of AFC.

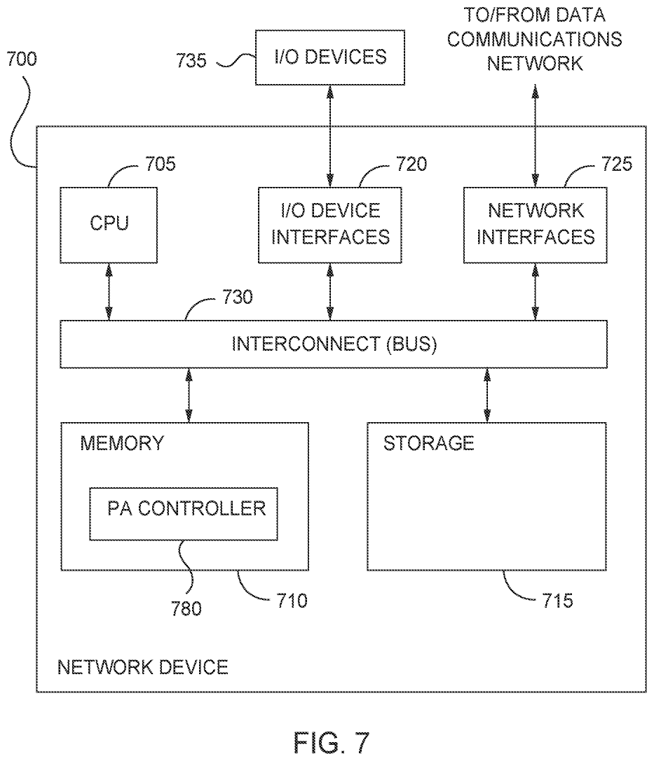

FIG. 7 depicts an example computing device (e.g., a network device 700) configured to perform various aspects of the present disclosure, according to some embodiments of the present disclosure. In some embodiments, the network device 700 corresponds to an network device 100 of FIG. 1. Although depicted as a physical device, in embodiments, the network device 700 may be implemented using virtual device(s), and/or across a number of devices (e.g., in a cloud environment).

As illustrated, the network device 700 includes a CPU 705, memory 710, storage 715, a network interface 725, and one or more I/O interfaces 720. In the illustrated embodiment, the CPU 705 (e.g., one or more processors) retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 735 (such as keyboards, monitors, etc.) are connected via the I/O interface(s) 720. Further, via the network interface 725, the network device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated embodiment, the memory 710 includes a PA controller 780 (e.g., a software application), which may perform one or more embodiments discussed above in FIGS. 1-6 where a non-linear PA is adaptively adjusted by changing its bias voltage and/or its backoff region. Although depicted as discrete components for conceptual clarity, in embodiments, the operations of the depicted components (and others not illustrated) may be combined or distributed across any number of components. Further, although depicted as software residing in memory 710, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device, comprising:
an antenna; and
an analog front end (FE) coupled to the antenna, the analog FE comprising a non-linear power amplifier (PA),
wherein the network device is configured to:
upon determining a wireless link satisfies a first performance threshold, adjust a bias voltage and a backoff region of the non-linear PA to a first voltage value and to a first backoff region, respectively; and
upon determining the wireless link does not satisfy the first performance threshold, adjust the bias voltage and the backoff region of the non-linear PA to a second voltage value and to a second backoff region, respectively.

2. The network device of claim 1, wherein the first voltage value is higher than the second voltage value and the first backoff region is greater than the second backoff region.

3. The network device of claim 2, wherein the first voltage value and the first backoff region support a higher modulation coding scheme (MCS) than the second voltage value and the second backoff region.

4. The network device of claim 3, wherein the first voltage value and the first backoff region support MCS11 or higher while the second voltage value and the second backoff region support MCS7 or lower.

5. The network device of claim 2, wherein the first backoff region is in a range of 7-12 dBm and the second backoff region is in a range of 2-5 dBm.

6. The network device of claim 1, wherein the first performance threshold is based on a signal-to-noise ratio (SNR) of the wireless link.

7. An access point (AP), comprising:
an antenna;
an analog front end (FE) coupled to the antenna, the analog FE comprising a non-linear power amplifier (PA),
wherein the AP is configured to:
determine that the AP can operate in Standard Power (SP) of Automated Frequency Coordination (AFC);
increase a bias voltage of the non-linear PA; and
decrease a backoff region of the non-linear PA.

8. The AP of claim 7, wherein the backoff region is decreased to be less than 5 dBm.

9. The AP of claim 8, wherein the bias voltage is increased to be above 4V.

10. The AP of claim 7, wherein increasing the bias voltage comprises:
increasing the bias voltage at fixed voltage steps over a predetermined period of time.

11. The AP of claim 7, wherein the AP is configured to, after determining the AP can operate in SP:
determine that the AP must operate in a lower power mode of AFC;
decrease the bias voltage of the non-linear PA; and
increase the backoff region of the non-linear PA.

12. The AP of claim 11, wherein the bias voltage is decreased below 4V and the backoff region is increased to 8 dBm or greater.

13. A method, comprising:
upon determining a wireless link satisfies a first performance threshold, adjusting a bias voltage and a backoff region of a non-linear PA to a first voltage value and to a first backoff region, respectively, wherein the non-linear PA is coupled to an antenna in a network device; and
upon determining the wireless link does not satisfy the first performance threshold, adjusting the bias voltage and the backoff region of the non-linear PA to a second voltage value and to a second backoff region, respectively.

14. The method of claim 13, wherein the first voltage value is higher than the second voltage value and the first backoff region is greater than the second backoff region.

15. The method of claim 14, wherein the first voltage value and the first backoff region support a higher modulation coding scheme (MCS) than the second voltage value and the second backoff region.

16. The method of claim 15, wherein the first voltage value and the first backoff region support MCS11 or higher while the second voltage value and the second backoff region support MCS7 or lower.

17. The method of claim 14, wherein the first backoff region is in a range of 7-12 dBm and the second backoff region is in a range of 2-5 dBm.

18. The method of claim 14, wherein the first performance threshold is based on a signal to noise ratio (SNR) of the wireless link.

19. The method of claim 14, wherein the non-linear PA is part of an analog FE.

20. The method of claim 19, wherein the analog FE and the antenna are part of an access point.
